(19) United States
(12) Patent Application Publication
(10) Pub. No.: US 2005/0236574 A1
(43) Pub. Date: Oct. 27, 2005

(54) Detector module for detecting X-radiation

(76) Inventor: Thomas Von Der Haar, Nuernberg (DE)

Correspondence Address: HARNESS, DICKEY & PIERCE, P.L.C., P.O.BOX 8910, RESTON, VA, 20195, US

(21) Appl. No.: 11/111,819

(22) Filed: Apr. 22, 2005

(30) Foreign Application Priority Data
Apr. 23, 2004 (DE) 10 2004 019 972.8

(51) Int. Cl. G01T 1/24

(52) U.S. Cl. 250/370.09

(57) ABSTRACT

A detector module is for detecting X-radiation and includes a multiplicity of detector elements. Each detector element includes an entrance surface for the X-radiation. Arranged upstream of the detector module is a collimator having a multiplicity of collimator plates that have a cross-sectional surface, perpendicular to the beam path. The collimator plates are arranged such that the cross-sectional surface shades the entrance surface with its entire width.

The present application hereby claims priority under 35 U.S.C. §119 on German patent application number DE 10 2004 019 972.8, filed Apr. 23, 2004, the entire contents of which is hereby incorporated herein by reference.

1. Field of the Invention

The invention generally relates to a detector module for detecting X-radiation.

2. Background of the Invention

According to the prior art, detector modules are used, for example, in computed tomography. In this case, an X-radiation emanating from an X-ray source and transmitted by an object is detected by detector elements. The detector elements can in each case include a scintillator element and a photodiode. In order to prevent crosstalk between the scintillator elements, the latter can be separated from one another by septa.

The X-radiation is scattered when traversing an object. The scattered radiation causes an increase in the noise component and a reduction in the contrast, and is therefore deleterious to the imaging quality.

The scattered radiation can be absorbed with the aid of a collimator arranged upstream of the detector elements in the beam path. Such a collimator is known, for example, from DE 100 11 877 C2. It includes a multiplicity of strongly absorbing collimator plates arranged essentially in parallel.

Each collimator plate has, perpendicular to the beam path, a cross-sectional surface that shades the detector module arranged downstream in the beam path. In conventional detector modules, the collimator plates are arranged lying over the septa in the beam direction. The septa usually are three times as thick as the collimator plates. Because of this, it is only the septa that are shaded by the cross-sectional surface.

The geometric efficiency of a detector module is given by the ratio of the surface of the detector elements to the overall surface area of the detector module. The geometric efficiency can be increased by reducing the thickness of the septa. However, a reduction in the thickness of the septa causes an increased outlay when positioning the collimator plates over the septa.

It can happen in practice that the collimator plates move relative to the detector as a consequence of thermal or mechanical influences. It can happen that the collimator plate partially shades the detector element in an undesired way. The size of the shaded surface is neither known nor constant with time. No correction of the shading is possible in this case, and so artefacts are produced in the X-ray image.

In conventional detector modules, the thickness of the septa is approximately 300 μm for collimator plates 100 μm thick. Raising the geometric efficiency by reducing the thickness of the septa is associated with a high outlay. The reduction in the thickness of the septa requires an increased accuracy in the positioning of the collimator plates over the septa. Furthermore, thin collimator plates with a small variance in thickness are required. This is complicated and expensive.

### SUMMARY OF THE INVENTION

It is an object of an embodiment of the invention to lessen or even remove at least one of the disadvantages according to the prior art. In particular, an aim of at least one embodiment is to specify a detector module that can be produced simply and cost-effectively. A detector module with an improved geometric efficiency is also to be specified in at least one embdiemnt.

An object of at least one embodiment may be achieved by a detector module.

It is provided according to at least one embodiment of the invention that the collimator plates are arranged with reference to the detector elements such that the cross-sectional surface shades the entrance surface with its entire width. Positioning via the septa that is exact and complicated may thus be reduced or even eliminated. The collimator plates may be arranged from the very beginning over the entrance surface of the detector elements. The outlay on exactly positioning the collimator plates over the septa may thus be reduced or even eliminated.

Moreover, it is possible in at least one embodiment to use collimator plates having a relatively large variance in thickness. Positioning, variance in thickness and the thickness of the septa are independent of one another over a wide range. Moreover, the thickness of the septa can be reduced to a thickness that is adequate for optical separation. The geometric efficiency can be increased thereby.

In the case of the detector module of at least one embodiment, a part of the entrance surface is shaded by the cross-sectional surface. The size of the shaded surface is essentially constant with time, and is known. The detector elements can be calibrated with reference to the shading.

According to a refinement of an embodiment of the invention, the array may be formed from a row of juxtaposed detector elements. Arrays with a row are used in computed tomography. The detector modules can be installed in a simple way in existing X-ray apparatuses. Complicated retrofitting may thus be reduced or even eliminated.

According to a further refinement of an embodiment of the invention, the collimator plates may be arranged substantially parallel to a z-direction. Such an arrangement can be used for a row of detector elements that are arranged in a φ-direction perpendicular to the z-direction. The collimator plates absorb scattered radiation in the φ-direction.

According to an advantageous refinement of an embodiment, the collimator plates may be arranged such that the cross-sectional surface shades the entrance surface approximately in the middle. In this case, the shaded surface, for example in the z-direction, lies approximately in the middle of the entrance surface. Moreover, the shaded surface, for example in the φ-direction, lies as far as possible from the edge of the entrance surface.

With this arrangement, the collimator plates can be positioned particularly easily in the φ-direction. Despite a change in position of the collimator plates relative to the detector elements, the shaded surface remains constant and known in the case of the proposed arrangement. A change in position of the collimator plates therefore does not cause artifacts in the X-ray edges.

According to a further refinement of an embodiment of the invention, the array may include a number of rows following one another in the z-direction. For example, the detector elements may be arranged like a chessboard. It may be advantageous in this case that the collimator has collimator plates arranged substantially parallel to a φ-direction. Such a collimator absorbs scattered radiation in the z-direction and in the φ-direction.

In a particularly advantageous refinement of an embodiment of the invention, the collimator plates may be arranged such that the cross-sectional surface shades the entrance surface approximately in the middle in the z-direction and/or φ-direction. The length or width of the entrance surface may be substantially larger than the thickness of a collimator plate. A particularly large clearance for the movements of the collimator plates may be provided for positioning approximately in the middle, in any event not in the vicinity of the edge of the entrance surface. The shaded surface remains constant and known in the event of small and customary thermally or mechanically induced movements of the collimator plates.

According to a further refinement of an embodiment of the invention, the collimator plates may be arranged such that, perpendicular to the beam path, the latter form a geometric, for example a linear, rectangular, honeycombed or a rhomboidal pattern. The pattern can be adapted to the shape of the detector elements. Furthermore, the collimator plates can be reciprocally stabilized in a two-dimensional, for example rectangular, arrangement such that their movements are reduced.

Furthermore, it is possible for the collimator plates to be formed in zigzag, corrugated or curved fashion perpendicular to the beam path of the X-radiation. The mechanical strength of the collimator can thereby be raised. The thickness required for adequate stability of the collimator plates can be reduced. The shaded surfaces of the entrance surfaces are reduced and the geometric efficiency is raised.

According to an advantageous refinement of an embodiment of the invention, the collimator plates may include a mean thickness of less than 150 μm perpendicular to the beam path. Thin collimator plates reduce the shaded surface and raise the geometric efficiency. The mechanical stability of such collimator plates can be raised by way of a suitable shape or a two-dimensional arrangement, for example.

According to a particularly advantageous refinement of an embodiment of the invention, the detector elements may be arranged at a spacing of at most 150 μm, preferably with the interposition of septa. The spacing of the detector elements, which is given, in particular, by the thickness of the septa, can be reduced to a minimum that is required for the optical separation. As a consequence of the substantial reduction, possible owing to the inventive arrangement, in the thickness of the septa, the entrance surface of the detector element can be correspondingly enlarged.

According to a further refinement of an embodiment of the invention, it is provided that the collimator plates have a length of approximately 1 cm to 4 cm in the direction of the beam path. Such a length is required for absorbing the scattered radiation as completely as possible. The length favorable for the absorption is a function of the thickness and the mutual spacing of the collimator plates. Collimator plates that are stabilized by their shape or arrangement can be produced with a relatively large length in the beam direction. This increases the absorption of scattered radiation.

It is provided furthermore that the collimator plates of at least one embodiment may be produced from Wo or Mo. Wo and Mo are suitable because of their good absorptive action, particularly for the production of collimator plates.

According to a further refinement of an embodiment of the invention, it is provided that the detector elements have transducers that convert radiation into electric or optical signals. The transducer can be, in particular, scintillator elements that are produced, for example, from a Gd₂OS ceramic. Given a flexible configuration of the functionality of the detector elements, the detector module can be used in a wide field.

At least one embodiment of the invention further provides a detector for detecting X-radiation, in particular for computed tomography, including a number of detector modules according to at least one embodiment of the invention. Such a detector has the advantages of the detector module according to at least one embodiment of the invention and can replace conventional detectors. Use is possible, for example, in computed tomography, in photographic inspection or in SPECT. The detector can be produced simply and cost-effectively. It has a higher efficiency by comparison with conventional detectors.

### BRIEF DESCRIPTION OF THE DRAWINGS

Example embodiments of the invention are explained in more detail below with the aid of the figures, in which:

FIG. 1 shows a perspective view of a section of a detector module and

FIG. 2 shows a plan view of a further detector module in the direction of an incident X-radiation.

### DETAILED DESCRIPTION OF THE EXAMPLE EMBODIMENTS

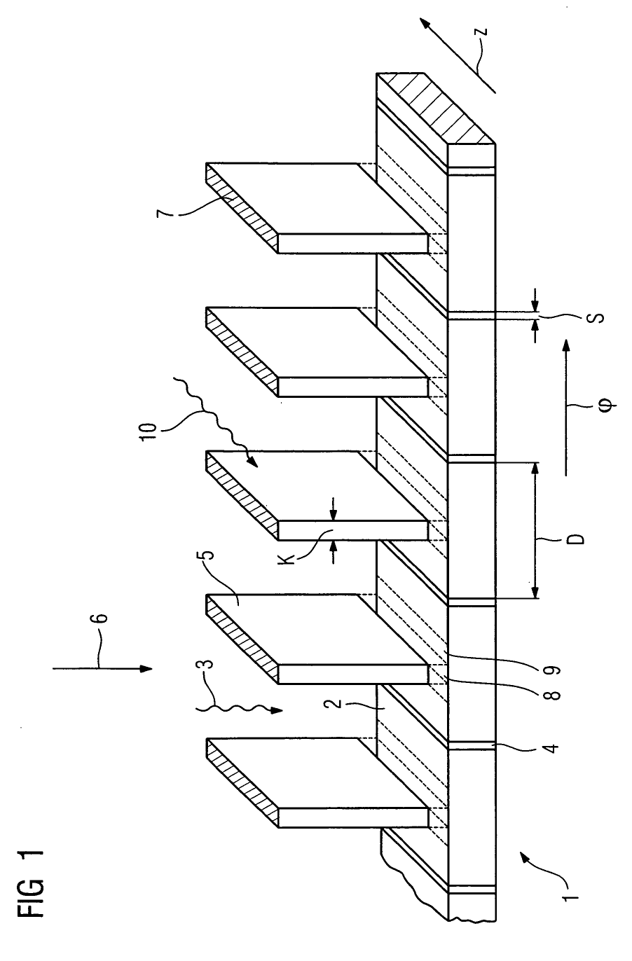

FIG. 1 shows a perspective view of a section of a detector module having a number of detector elements 1 arranged next to one another in a z-direction. This can be a scintillator ceramic. A number of detector elements 1 are arranged next to one another in a row parallel to a φ-direction φ. Each detector element 1 has an entrance surface 2 for X-radiation 3. A septum 4 is located between two detector elements 1 in each case.

Collimator plates 5 are arranged over the detector elements 1. The collimator plates 5 are substantially parallel to a z-direction z. The z-direction z is perpendicular to the φ-direction φ. Each collimator plate 5 has a cross-sectional surface 7 perpendicular to the incidence direction 6 of the X-radiation 3. The reference numeral 8 denotes a shaded surface of the entrance surface 2.

The shaded surface 8 lies approximately in the middle of the entrance surface 2. The reference numeral 9 describes a shading zone lying in the entrance surface 2 and given by a movement of the collimator plate 5. The collimator plates 5 are always arranged with reference to the detector elements 1 such that the shading zone 9 is located completely inside the entrance surface 2. This ensures that the entrance surface 2 is always shaded by the shaded surface 8. In the φ-direction φ, the collimator plates 5 have a thickness K, the detector elements 1 have a length D and the septa 4 have a width S. A scattered radiation is denoted by the reference numeral 10.

The detector module functions as follows:

the detector elements 1 detect the X-radiation 3 incident in the direction 6. The septa 4 arranged between in each case two detector elements 1 prevent optical crosstalk between the detector elements 1. The collimator plates 5 are arranged upstream of the detector elements 1 in the incidence direction 6 of the X-radiation 3 in order to absorb the scattered radiation 10. The entrance surface 2 is reduced by a shaded surface 8 that is caused by an absorption of X-radiation in the cross-sectional surface 7. The septa 2 are not shaded.

A movement of the collimator plate 5 can be caused thermally or mechanically, and can be in the range of approximately 100 μm. The size of the shaded surface 8 remains constant during movement. The shaded surface 8 is always located in the shading zone 9. The size of the shaded surface 8 is known. This permits the detector elements 1 to be calibrated such that the movement does not cause any artefacts in an X-ray picture.

Arranging the collimator plates 5 approximately in the middle over the detector elements 1 is particularly favorable. The length D of the detector elements 1 is substantially greater, for example by a factor of 10, than the thickness K of the collimator plates 5. There is a wide clearance for positioning in the φ-direction φ over the length D, for example 100-200 μm. The positioning can be executed in a simple way. The width S of the septa is reduced, to a minimum for example, so as precisely to prevent optical crosstalk between the detector elements 1.

A geometric efficiency η_{geo} can be calculated as follows in a simple way for the given detector module:
η_{geo}=(D−K)/(D+S)

In general, the geometric efficiency is given by the ratio of a surface area detecting X-radiation to an overall surface area of a detector.

D=1.4 mm in the case of the given detector module. The collimator plates 5 are 100 μm thick, K=100 μm. An adequate optical separation of the detector elements 1 can be achieved with a width S of the septa of 100 μm. The η_{geo} of the detector module is 86.67%.

A geometric efficiency of only 80% is achieved with detector modules, known from the prior art, for which the collimator plates 5 are arranged in the middle above the septa 4.

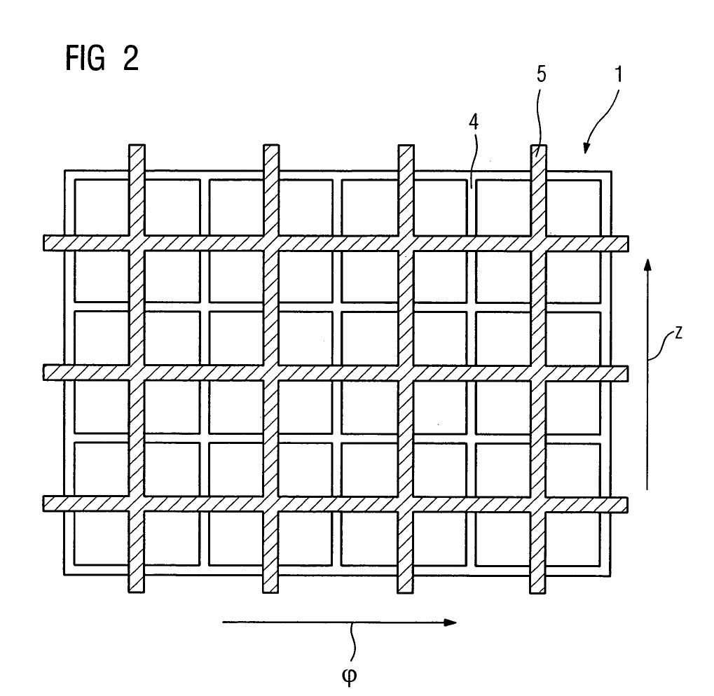

FIG. 2 shows a detector module having three detector rows following one another in the z-direction z. The detector elements 1 are arranged like a chessboard and separated from one another by septa 4. Collimator plates 5 are arranged approximately in the middle over the detector elements 1. The collimator plates 5 form a grid in a fashion perpendicular to the z-direction z and φ-direction φ, and can stabilize one another reciprocally.

By analogy with FIG. 1, it is easily possible to position the collimator plates 5 in the middle over the detector elements 1. The positioning need not be carried out exactly to a few micrometers in the z-direction z and in the φ-direction φ. Furthermore, for movements of the collimator plates 5, for example by 100-200 μm, the shaded surface of the detector elements remains constant such that no artefacts are caused in X-ray images.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A detector module for detecting X-radiation, comprising:
an array formed from detector elements, each detector element having an entrance surface for the X-radiation; and
a collimator arranged upstream of the detector elements in a beam path of the X-radiation, the collimator including a multiplicity of collimator plates, each collimator plate having a cross-sectional surface, perpendicular to the beam path, the collimator plates being arranged with reference to the detector elements such that the cross-sectional surface shades the entrance surface with its entire width.

2. The detector module as claimed in claim 1, wherein the array is formed from a row of juxtaposed detector elements.

3. The detector module as claimed in claim 1, wherein the collimator plates are arranged substantially parallel to a z-direction.

4. The detector module as claimed in claim 1, wherein the collimator plates are arranged such that the cross-sectional surface shades the entrance surface approximately in the middle.

5. The detector module as claimed in claim 1, wherein the array has a number of rows following one another in the z-direction.

6. The detector module as claimed in claim 1, wherein the collimator has collimator plates arranged substantially parallel to a φ-direction.

7. The detector module as claimed in claim 6, wherein the collimator plates are arranged such that the cross-sectional surface shades the entrance surface approximately in the middle in at least one of the z-direction and φ-direction.

8. The detector module as claimed in claim 1, wherein the collimator plates are arranged such that, perpendicular to the beam path, the latter form a geometric pattern.

9. The detector module as claimed in claim 1, wherein the collimator plates have a mean thickness of less than 150 μm perpendicular to the beam path.

10. The detector module as claimed in claim 1, wherein the detector elements are arranged at a spacing of at most 150 μm, with the interposition of septa.

11. The detector module as claimed in claim 1, wherein the collimator plates have a length of approximately 1 cm to 4 cm in the direction of the beam path.

12. The detector module as claimed in claim 1, wherein the collimator plates are produced from at least one of Wo and Mo.

13. The detector module as claimed in claim 1, wherein the detector elements have transducers that convert radiation into at least one of electric and optical signals.

14. A detector for detecting X-radiation, comprising a number of detector modules as claimed in claim 1.

15. The detector module of claim 1, wherein the detector module is for computed tomography.

16. The detector module as claimed in claim 2, wherein the collimator plates are arranged substantially parallel to a z-direction.

17. The detector module as claimed in claim 2, wherein the collimator plates are arranged such that the cross-sectional surface shades the entrance surface approximately in the middle.

18. The detector module as claimed in claim 8, wherein the geometric pattern is one of a linear, rectangular, honeycombed and a rhomboidal pattern.

19. A detector for detecting X-radiation for computed tomography, comprising a number of detector modules as claimed in claim 1.
